(19) United States
(12) Patent Application Publication
(10) Pub. No.: US 2022/0035263 A1
(43) Pub. Date: Feb. 3, 2022

(54) TONER, IMAGE FORMING APPARATUS, AND IMAGE FORMATION METHOD

(71) Applicant: KYOCERA Document Solutions Inc., Osaka (JP)

(72) Inventors: Takeo MIZOBE, Osaka-shi (JP); Naruo YABE, Osaka-shi (JP); Takeshi ARAKAWA, Osaka-shi (JP); Masanori SUGAHARA, Osaka-shi (JP); Ryota KOBAYASHI, Osaka-shi (JP)

(73) Assignee: KYOCERA Document Solutions Inc., Osaka (JP)

(21) Appl. No.: 17/388,999

(22) Filed: Jul. 29, 2021

(30) Foreign Application Priority Data
Jul. 30, 2020 (JP) 2020-129239

(51) Int. Cl. G03G 9/097; G03G 9/08; G03G 15/08

(52) U.S. Cl. CPC G03G 9/09766; G03G 15/0812; G03G 9/0819

(57) ABSTRACT

A toner includes toner particles. The toner particles each include a toner mother particle containing a binder resin and an external additive attached to a surface of the toner mother particle. The external additive includes fluororesin particles. The fluororesin particles have a number average primary particle diameter of at least 100 nm and no greater than 300 nm. An area ratio of a region of the surface of the toner mother particle that is covered with the fluororesin particles is at least 0.70% and no greater than 2.20% in the surface of the toner mother particle.

### INCORPORATION BY REFERENCE

The present application claims priority under 35 U.S.C. § 119 to Japanese Patent Application No. 2020-129239, filed Jul. 30, 2020. The contents of this application are incorporated herein by reference in their entirety.

### BACKGROUND

The present disclosure relates to a toner, an image forming apparatus, and an image formation method.

Typically, an electrographic image forming apparatus includes a development device with a developer bearing member (toner bearing member) that bears a developer and a layer-thickness limiting member that limits the thickness of a developer layer (toner layer). Examples of the developer include a one-component developer that includes only a toner and a two-component developer that includes a toner and a carrier.

Examples of the one-component developer include a magnetic one-component developer with toner particles that include a magnetic powder and a non-magnetic one-component developer with toner particles that include no magnetic powder. In an image forming apparatus that performs development using the non-magnetic one-component developer, the layer-thickness limiting member (e.g., a layer-thickness limiting blade) of the development device is disposed so as to be in contact with the surface of the toner bearing member. In the following, a process of development using a non-magnetic one-component developer by a development device in which a layer-thickness limiting member is provided in contact with the surface of a toner bearing member may be referred to as a “non-magnetic one-component development process”.

In image formation by the non-magnetic one-component development process, toner tends to readily adhere to the layer-thickness limiting member due to the layer-thickness limiting member being in contact with the surface of the toner bearing member. Adhesion of the toner to the layer-thickness limiting member is liable to cause image defects (specific examples include streak formation).

In order to inhibit production of image defects, an example of a toner includes resin particles constituted by acrylic resin as external additive particles.

### SUMMARY

A toner according to an aspect of the present disclosure includes toner particles. The toner particles each include a toner mother particle containing a binder resin and an external additive attached to a surface of the toner mother particle. The external additive includes fluororesin particles. The fluororesin particles have a number average primary particle diameter of at least 100 nm and no greater than 300 nm. An area ratio of a region of the surface of the toner mother particle that is covered with the fluororesin particles is at least 0.70% and no greater than 2.20% in the surface of the toner mother particle.

An image forming apparatus according to another aspect of the present disclosure includes an image bearing member and a development device that develops an electrostatic latent image formed on a surface of the image bearing member by supplying a non-magnetic one-component developer to the electrostatic latent image. The non-magnetic one-component developer is the toner according to the present disclosure. The development device includes a toner bearing member that bears the toner and a layer-thickness limiting member that limits a thickness of a toner layer formed from the toner. The development device supplies the toner to the electrostatic latent image while forming the toner layer using the layer-thickness limiting member in contact with the toner bearing member.

An image formation method according to yet another aspect of the present disclosure is an image formation method that uses the toner according to the present disclosure as a non-magnetic one-component developer, and includes forming an electrostatic latent image on a surface of an image bearing member and developing the electrostatic latent image by supplying the toner to the electrostatic latent image while forming a toner layer formed from the toner using a layer-thickness limiting member in contact with a toner bearing member.

### BRIEF DESCRIPTION OF THE DRAWINGS

FIG. 1 is a diagram illustrating an example of a sectional structure of a toner particle included in a toner according to a first embodiment of the present disclosure.

FIG. 2 is a diagram illustrating an example of a configuration of an image forming apparatus according to a second embodiment of the present disclosure.

FIG. 3 is a diagram illustrating a configuration of a development device included in the image forming apparatus in FIG. 2.

### DETAILED DESCRIPTION

The following describes preferred embodiments of the present disclosure. First of all, terms used in the present specification will be described. “Fluororesin” refers to a resin including a fluorine atom. “Constitutional resin” refers to a resin constituting resin particles. “Fluororesin particles” refer to resin particles of which constitutional resin is fluororesin. A toner is a collection (e.g., a powder) of toner particles. An external additive is a collection (e.g., a powder) of external additive particles. Unless otherwise stated, evaluation results (e.g., values indicating shape or physical properties) of a powder (specific examples include a powder of toner particles and a powder of external additive particles) are number averages of values measured with respect to an appropriate number of particles selected from the powder.

Measurement values for volume median diameter (D₅₀) of particles (specifically, a powder of particles) are median diameters in terms of volume measured using a laser diffraction/scattering particle size distribution analyzer (“LA-750”, product of Horiba, Ltd.) unless otherwise stated. Unless otherwise stated, the number average particle diameter of a powder is a number average value of equivalent circle diameters of 100 primary particles of the powder (Heywood diameters: diameters of circles having the same areas as projected areas of the respective particles) measured using a scanning electron microscope (“JSM-7401F”, product of JEOL Ltd.) and image analysis software (“WinROOF”, product of MITANI CORPORATION). Note that the number average primary particle diameter of particles is a number average primary particle diameter of the particles of a powder (number average primary particle diameter of the powder) unless otherwise stated.

The level of chargeability refers to susceptibility to triboelectric charging unless otherwise stated. For example, a measurement target (e.g., a toner) is triboelectrically charged by mixing and stirring the measurement target with a standard carrier (standard carrier for negatively chargeable toner: N-01, standard carrier for positively chargeable toner: P-01) provided by The Imaging Society of Japan. The amount of charge of the measurement target is measured before and after triboelectric charging using for example a compact toner draw-off charge measurement system (“MODEL 212HS”, product of TREK, INC.). The measurement target with a larger change in an amount of charge between before and after triboelectric charging has stronger chargeability.

Measurement values for softening point (Tm) are values measured using a capillary rheometer (“CFT-500D”, produced by Shimadzu Corporation) unless otherwise stated. On an S-shaped curve (vertical axis: temperature, horizontal axis: stroke) measured using the capillary rheometer, the softening point (Tm) is equivalent to a temperature corresponding to a stroke value of “(base line stroke value+maximum stroke value)/2”.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof.

### First Embodiment: Toner

A toner according to a first embodiment of the present disclosure can be favorably used for example as a positively chargeable toner for development of electrostatic latent images. The toner of the first embodiment is a collection (e.g., a powder) of toner particles (particles each having features described later). The toner of the first embodiment is a non-magnetic one-component developer, for example. The non-magnetic one-component developer is for example positively charged by friction with a toner bearing member or a layer-thickness limiting member in a development device.

The toner particles included in the toner of the first embodiment each include a toner mother particle containing a binder resin and an external additive attached to the surface of the toner mother particle. The external additive includes fluororesin particles. The fluororesin particles have a number average primary particle diameter of at least 100 nm and no greater than 300 nm. An area rate of a region of the surface of the toner mother particle that is covered with the fluororesin particles is at least 0.70% and no greater than 2.20% in the surface of the toner mother particle.

In the following, an area rate (unit: %) of the region of the surface of the toner mother particle that is covered with the fluororesin particles in the surface of the toner mother particle may be also referred to below as a “fluorine coverage rate”. The fluorine coverage rate is determined according to the same method as that in later-described Examples or a method equivalent thereto.

As a result of the toner of the first embodiment having the above-described features, production of image defects can be inhibited in image formation by the non-magnetic one-component development process. Presumably, the reasons for this are as follows.

In the toner of the first embodiment, the external additive includes fluororesin particles. The fluororesin particles tend to be difficult to adhere to any other materials. Furthermore, in the toner of the first embodiment, the fluororesin particles included in the external additive have a number average primary particle diameter of at least 100 nm and no greater than 300 nm. As such, in the toner of the first embodiment, the fluororesin particles are inhibited from being buried in a surface portion of the toner mother particles and inhibited from detaching from the toner mother particles in a development device. Furthermore, the toner of the first embodiment has a fluorine coverage rate of at least 0.70%. From the above, the toner of the first embodiment tends to be difficult to adhere to a layer-thickness limiting member in image formation by the non-magnetic one-component development process. Therefore, the toner of the first embodiment can inhibit production of image defects (specific examples include streak formation) due to the toner adhering to the layer-thickness limiting member in image formation by the non-magnetic one-component development process.

By contrast, an excessively high fluorine coverage rate tends to lead to excessive increase in the amount of toner forming a toner layer. However, the toner of the first embodiment has a fluorine coverage rate of no greater than 2.20%. As such, the fluorine coverage rate of the toner of the first embodiment has an upper limit so that the amount of toner forming a toner layer does not increase excessively. Therefore, when using the toner of the first embodiment, production of image defects (specific examples include fogging) due to excessive increase in the amount of toner forming a toner layer can be inhibited.

As described above, the toner of the first embodiment can inhibit production of image defects due to adhesion of toner to the layer-thickness limiting member and image defects due to excessive increase in the amount of toner forming the toner layer. As a result, production of image defects can be inhibited in image formation by the non-magnetic one-component development process.

In the first embodiment, the fluorine coverage rate is preferably at least 0.72% in order to further inhibit occurrence of streak formation. Furthermore, in the first embodiment, the fluorine coverage rate is preferably no greater than 1.09% in order to further inhibit occurrence of fogging.

In the first embodiment, the amount of the fluororesin particles is preferably at least 0.30 parts by mass relative to 100 parts by mass of the toner mother particles in order to further inhibit occurrence of streak formation. Yet in the first embodiment, the amount of the fluororesin particles is preferably no greater than 0.60 parts by mass relative to 100 parts by mass of the toner mother particles in order to further inhibit occurrence of fogging. In particular, in a case in which the toner of the first embodiment is a positively chargeable toner, the toner can have excellent anti-fogging property when the amount of the fluororesin particles is no greater than 0.60 parts by mass relative to 100 parts by mass of the toner mother particles.

The toner particles included in the toner of the first embodiment may be toner particles not including shell layers or toner particles including shell layers (also referred to below as capsule toner particles). In the capsule toner particles, the toner mother particles each include a toner core containing a binder resin and a shell layer covering the surface of the toner core. The shell layers contain a resin. Both heat-resistant preservability and low-temperature fixability of the toner can be achieved for example by using low temperature-melting toner cores and covering each toner core with a highly heat-resistant shell layer. An additive may be dispersed in the resin constituting the shell layers. The shell layers may cover the entirety of the surfaces of the toner cores or partially cover the surfaces of the toner cores.

In the first embodiment, the toner mother particles may further contain an internal additive (e.g., at least one of a colorant, a releasing agent, and a charge control agent) as necessary besides the binder resin.

Details of the toner of the first embodiment will be described next with reference to a drawing as appropriate. Note that the drawing schematically illustrates main elements of configuration in order to facilitate understanding. Properties such as size, number, and shape of the elements of configuration illustrated in the drawing may differ from actual properties in order to facilitate preparation of the drawing.

[Features of Toner Particles]

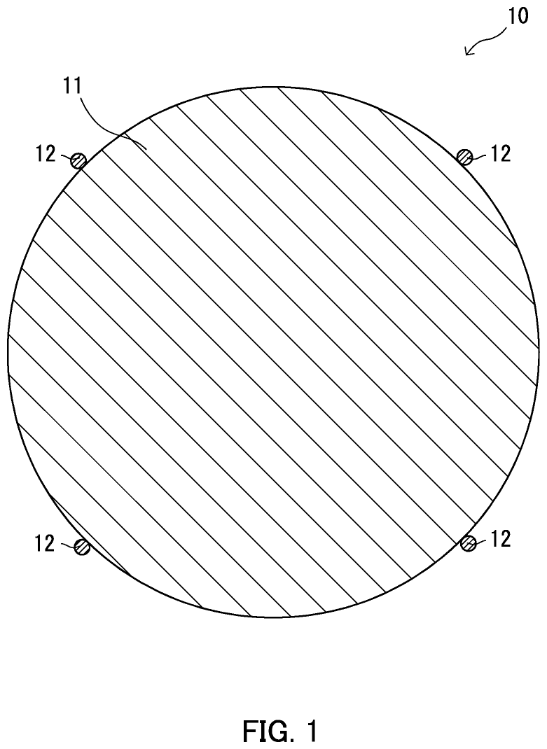

The following describes features of the toner particles included in the toner of the first embodiment with reference to FIG. 1. FIG. 1 is a diagram illustrating an example of a sectional structure of a toner particle included in the toner of the first embodiment.

A toner particle 10 illustrated in FIG. 1 includes a toner mother particle 11 containing a binder resin and an external additive attached to the surface of the toner mother particle 11. The external additive includes fluororesin particles 12 as external additive particles.

The fluororesin particles 12 have a number average primary particle diameter of at least 100 nm and no greater than 300 nm. An area ratio (fluorine coverage rate) of a region of the surface of the toner mother particle 11 that is covered with the fluororesin particles 12 is at least 0.70% and no greater than 2.20% in the surface of the toner mother particle 11.

In order for the toner to be suitable for image formation, the toner mother particles 11 preferably have a volume median diameter (D₅₀) of at least 4 μm and no greater than 9 μm.

Example features of the toner particles included in the toner of the first embodiment have been described so far with reference to FIG. 1.

[Elements of Toner Particle]

Elements of each toner particle included in the toner of the first embodiment will be described next.

(Binder Resin)

The binder resin accounts for no less than 70% by mass of the components of the toner mother particles, for example. Accordingly, properties of the binder resin are thought to have a great influence on overall properties of the toner mother particles. In order for the toner to have excellent low-temperature fixability, the toner mother particles preferably contain a thermoplastic resin as the binder resin and more preferably contain a thermoplastic resin at a ratio of at least 85% by mass relative to an entire amount of the binder resin. Examples of the thermoplastic resin include styrene-based resins, acrylic acid ester-based resins, olefin-based resins (specific examples include polyethylene resin and polypropylene resin), vinyl resins (specific examples include vinyl chloride resin, polyvinyl alcohol, vinyl ether resin, and N-vinyl resin), polyester resins, polyamide resins, and urethane resins. It is also possible to use as the binder resin a copolymer of any of the above resins, that is, a copolymer into which any repeating unit is introduced in any of these resins (specific examples include styrene-acrylic acid ester-based resin and styrene-butadiene-based resin).

The thermoplastic resin can be obtained through addition polymerization, copolymerization, or condensation polymerization of one or more thermoplastic monomers. Note that the thermoplastic monomers each are monomers that form a thermoplastic resin through homopolymerization (specific examples include acrylic acid-ester-based monomers and styrene-based monomers) or monomers that form a thermoplastic resin through condensation polymerization (e.g., a combination of a polyhydric alcohol and a polybasic carboxylic acid that form a polyester resin through condensation polymerization).

In order for the toner to have excellent low-temperature fixability, the toner mother particles preferably contain a polyester resin as the binder resin, and more preferably contain a polyester resin at a ratio of at least 90% by mass and no greater than 100% by mass to the total amount of the binder resin. The polyester resin can be obtained through condensation polymerization of one or more polyhydric alcohols and one or more polybasic carboxylic acids. Examples of a polyhydric alcohol that can be used for synthesis of the polyester resin include dihydric alcohols (specific examples include aliphatic diols and bisphenols) and tri- or higher-hydric alcohols listed below. Examples of a polybasic carboxylic acid that can be used for synthesis of the polyester resin include dibasic carboxylic acids and tri- or higher-basic carboxylic acids listed below. Note that a derivative of the polybasic carboxylic acid that can form an ester bond through condensation polymerization (specific examples include an anhydride of the polybasic carboxylic acid and a halide of the polybasic carboxylic acid) may be used instead of the polybasic carboxylic acid.

Preferable examples of the aliphatic diols include diethylene glycol, triethylene glycol, neopentyl glycol, 1,2-propanediol, α,ω-alkanediols (specific examples include ethylene glycol, 1,3-propanediol, 1,4-butanediol, 1,5-pentanediol, 1,6-hexanediol, 1,7-heptanediol, 1,8-octanediol, 1,9-nonanediol, and 1,12-dodecanediol), 2-butene-1,4-diol, 1,4-cyclohexanedimethanol, dipropylene glycol, polyethylene glycol, polypropylene glycol, and polytetramethylene glycol.

Preferable examples of the bisphenols include bisphenol A, hydrogenated bisphenol A, bisphenol A ethylene oxide adduct, and bisphenol A propylene oxide adduct.

Preferable examples of the tri- or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Preferable examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, 1,10-decanedicarboxylic acid, succinic acid, alkyl succinic acids (specific examples include n-butylsuccinic acid, isobutylsuccinic acid, n-octylsuccinic acid, n-dodecylsuccinic acid, and isododecylsuccinic acid), and alkenyl succinic acids (specific examples include n-butenylsuccinic acid, isobutenylsuccinic acid, n-octenylsuccinic acid, n-dodecenylsuccinic acid, and isododecenylsuccinic acid).

Preferable examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and EMPOL trimer acid.

(Colorant)

The toner mother particles may contain a colorant. The colorant can be a known pigment or dye that matches the color of the toner. The amount of the colorant is preferably at least 1 part by mass and no greater than 20 parts by mass relative to 100 parts by mass of the binder resin in order to form high-quality images using the toner.

The toner mother particles may contain a black colorant. Carbon black can be used as a black colorant, for example. Alternatively, as a black colorant, a colorant can be used that has been adjusted to a black color using colorants such as a yellow colorant, a magenta colorant, and a cyan colorant.

The toner mother particles may contain a non-black colorant. Examples of the non-black colorant include a yellow colorant, a magenta colorant, and a cyan colorant.

At least one compound selected from the group consisting of a condensed azo compound, an isoindolinone compound, an anthraquinone compound, an azo metal complex, a methine compound, and an arylamide compound can used as the yellow colorant. Examples of the yellow colorant include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, and C.I. Vat Yellow.

At least one compound selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound, and a perylene compound can be used as the magenta colorant. Examples of the magenta colorant include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254).

At least one compound selected from the group consisting of a copper phthalocyanine compound, an anthraquinone compound, and a basic dye lake compound can be used as the cyan colorant. Examples of the cyan colorant include C.I. Pigment Blue (1, 7, 15, 15:1, 15:2, 15:3, 15:4, 60, 62, or 66), Phthalocyanine Blue, C.I. Vat Blue, and C.I. Acid Blue.

(Releasing Agent)

The toner mother particles may contain a releasing agent. A releasing agent is used for the purpose of the toner having excellent offset resistance, for example. The amount of the releasing agent is preferably at least 1 part by mass and no greater than 20 parts by mass relative to 100 parts by mass of the binder resin in order for the toner to have excellent offset resistance.

Examples of the releasing agent include ester waxes, polyolefin waxes (specific examples include polyethylene wax and polypropylene wax), microcrystalline wax, fluororesin wax, Fischer-Tropsch wax, paraffin wax, candelilla wax, montan wax, and castor wax. Examples of the ester waxes include natural ester waxes (specific examples include carnauba wax and rice wax) and synthetic ester waxes. In the first embodiment, one releasing agent may be used independently or two or more releasing agents may be used in combination.

A compatibilizer may be added to the toner mother particles in order to improve compatibility between the binder resin and the releasing agent.

(Charge Control Agent)

The toner mother particles may contain a charge control agent. A charge control agent is used for example for the purpose of the toner having excellent charge stability or an excellent charge rise characteristic. The charge rise characteristic of the toner is an indicator as to whether or not the toner can be charged to a predetermined charge level within a short period of time.

The cationic strength (positive chargeability) of the toner mother particles can be increased through the toner mother particles containing a positively chargeable charge control agent. By contrast, the anionic strength (negative chargeability) of the toner mother particles can be increased through the toner mother particles containing a negatively chargeable charge control agent.

Examples of the positively chargeable charge control agent include: azine compounds such as pyridazine, pyrimidine, pyrazine, 1,2-oxazine, 1,3-oxazine, 1,4-oxazine, 1,2-thiazine, 1,3-thiazine, 1,4-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes such as Azine Fast Red FC, Azine Fast Red 12BK, Azine Violet BO, Azine Brown 3G, Azine Light Brown GR, Azine Dark Green BH/C, Azine Deep Black EW, and Azine Deep Black 3RL; acid dyes such as Nigrosine BK, Nigrosine NB, and Nigrosine Z; alkoxylated amine; alkylamide; quaternary ammonium salts such as benzyldecylhexylmethyl ammonium chloride, decyltrimethyl ammonium chloride, 2-(methacryloyloxy)ethyl trimethylammonium chloride, and dimethylaminopropyl acrylamide methyl chloride quaternary salt; and resins having a quaternary ammonium cation group. One of the charge control agents listed above may be used independently, or two or more of the charge control agents listed above may be used in combination.

An example of the negatively chargeable charge control agent is an organic metal complex that is a chelate compound. Preferable examples of the organic metal complex include at least one selected from the group consisting of a metal acetylacetonate complex, a salicylic acid-based metal complex, and salts of these.

The amount of the charge control agent is preferably at least 0.1 parts by mass and no greater than 20 parts by mass relative to 100 parts by mass of the binder resin in order for the toner to have excellent charge stability.

(External Additive)

The toner particles included in the toner of the first embodiment include an external additive attached to the surfaces of the toner mother particles. The external additive includes one or two or more types of fluororesin particles as external additive particles. An additive (specific examples include an emulsifier) may be attached to a part of each surface of the fluororesin particles.

Examples of the fluororesin constituting the fluororesin particles include polytetrafluoroethylene (also referred to below as “PTFE”), perfluoroalkoxy fluororesin, polychlorotrifluoroethylene, polyvinylidene fluoride, polydichlorodifluoroethylene, tetrafluoroethylene-perfluoroalkylvinylether copolymers, tetrafluoroethylene-hexafluoropropylene copolymers, tetrafluoroethylene-ethylene copolymers, tetrafluoroethylene-hexafluoropropylene-perfluoroalkylvinyl ether copolymers, and tetrafluoroethylene-perfluoroalkoxyethylene copolymers. One or two or more fluororesins can be used as the fluororesin constituting the fluororesin particles.

In order to further inhibit occurrence of streak formation, the fluororesin particles are preferably particles containing PTFE and more preferably fluororesin particles constituted by PTFE.

In order to further inhibit occurrence of streak formation and further inhibit occurrence of fogging, it is preferable that the fluororesin particles included in the external additive be fluororesin particles constituted by PTFE and the fluororesin coverage rate be at least 0.72% and no greater than 1.09%.

No particular limitations are placed on the production method of the fluororesin particles. Commercially available fluororesin particles can alternatively be used for the toner of the first embodiment.

The following describes an example of the production method of the fluororesin particles. First, an autoclave is charged with water (specific examples include ion exchange water), an emulsifier (specific examples include ammonium perfluorohexanoate), and a wax (specific examples include paraffin wax). Next, the internal air of the autoclave is replaced by nitrogen gas and a material gas of fluororesin (specific examples include tetrafluoroethylene gas) while the internal temperature of the autoclave is kept at a specific temperature (e.g., at least 70° C. and no higher than 90° C.).

Next, after a polymerization initiator solution (specific examples include an ammonium persulfate solution and a disuccinic acid peroxide solution) is added under pressure into the autoclave, the material gas of the fluororesin is supplied to the autoclave continuously to cause a polymerization reaction. During the polymerization reaction, the autoclave contents are continuously stirred at a rotational speed of at least 200 rpm and no greater than 300 rpm while the internal temperature of the autoclave is kept at a specific temperature (e.g., at least 70° C. and no higher than 90°). After a specific time period has elapsed (e.g., no shorter than 30 minutes and no longer than 60 minutes) from addition under pressure of the polymerization initiator solution (start of stirring of the autoclave contents), supply of the material gas is stopped and stirring of the autoclave contents is stopped to terminate the polymerization reaction.

Next, precipitation is carried out. In detail, after concentrated nitric acid is first added to a dispersion (autoclave contents) as a result of the polymerization reaction, the dispersion to which the concentrated nitric acid has been added is stirred at a rotational speed of at least 300 rpm and no greater than 500 rpm for a specific time period (e.g., no shorter than 30 minutes and no longer than 2 hours) to precipitate a polymer. Next, the dispersion after precipitation is subjected to solid-liquid separation and the resultant solid is dried. Through the above, a powder of fluororesin particles is obtained.

The number average primary particle diameter of the fluororesin particles can be adjusted for example by changing at least one of time from a start of addition under pressure of the polymerization initiator to stop of supply of the material gas (time during which the autoclave contents are stirred) and the rotational speed (stirring speed) in stirring the dispersion in precipitation in the above example of the production method of the fluororesin particles.

As the external additive particles, the external additive may include only the fluororesin particles or may further include additional external additive particles other than the fluororesin particles. In order to favorably maintain fluidity of the toner, the additional external additive particles are preferably inorganic particles, and more preferably silica particles.

The additional external additive particles may be surface-treated. For example, in a situation in which silica particles are used as the additional external additive particles, either or both hydrophobicity and positive chargeability may be imparted to the surfaces of the silica particles using a surface treatment agent. Examples of the surface treatment agent include coupling agents (specific examples include a silane coupling agent, a titanate coupling agent, and an aluminate coupling agent), silazane compounds (specific examples include a chain silazane compound and a cyclic silazane compound), and silicone oils (specific examples include dimethyl silicone oil). The surface treatment agent is preferably at least one selected from the group consisting of a silane coupling agent and a silazane compound. Preferable examples of the silane coupling agent include silane compounds (specific examples include methyltrimethoxysilane and aminosilane). A preferable example of the silazane compound is hexamethyldisilazane (HMDS). When the surface of a silica base (untreated silica particles) is treated with a surface treatment agent, a large number of hydroxyl groups (—OH) on the surface of the silica base are partially or entirely replaced by functional groups derived from the surface treatment agent. As a result, silica particles having the functional groups derived from the surface treatment agent (specifically, functional groups with higher hydrophobicity and/or higher positive chargeability than a hydroxy group) on the surface thereof are obtained.

In order to allow the external additive to fully exhibit its function while inhibiting detachment of the external additive from the toner mother particles, the amount of the external additive (where the additional external additive particles are used, a total amount of the fluororesin particles and the additional external additive particles) is preferably at least 0.1 parts by mass and no greater than 10.0 parts by mass relative to 100 parts by mass of the toner mother particles.

[Toner Production Method]

A preferable production method of the toner of the first embodiment will be described next.

(Toner Mother Particle Preparation)

First, the toner mother particles are prepared by an aggregation method or a pulverization method.

The aggregation method includes an aggregation process and a coalescence process. The aggregation process involves causing fine particles containing components constituting the toner mother particles to aggregate in an aqueous medium to form aggregated particles. The coalescence process involves causing the components contained in the aggregated particles to coalesce in the aqueous medium to form toner mother particles.

The pulverization method will be described next. By the pulverization method, the toner mother particles can be prepared relatively easily and manufacturing cost can be reduced. In the toner mother particle preparation by the pulverization method, the toner mother particle preparation includes a melt-kneading process and a pulverization process, for example. The toner mother particle preparation may further include a mixing process before the melt-kneading process. Alternatively or additionally, the toner mother particle preparation may further include at least one of a fine pulverization process and a classification process after the pulverization process.

In the mixing process, the binder resin and an internal additive added as needed are mixed together to yield a mixture. In the melt-kneading process, a toner material is melted and kneaded to yield a melt-kneaded product. The mixture yielded in the mixing process is for example used as the toner material. In the pulverization process, the resultant melt-kneaded product is cooled to for example room temperature (25° C.) and then pulverized to yield a pulverized product. Where it is necessary to reduce the diameter of the pulverized product yielded in the pulverization process, the pulverized product may be further pulverized (fine pulverization process). Alternatively or additionally, the resultant pulverized product may be classified (classification process) in order to uniform the particle diameter of the pulverized product. Through the above, the toner mother particles that correspond to the pulverized product can be obtained.

(External Additive Addition)

Thereafter, the resultant toner mother particles and the external additive are mixed using a mixer to attach the external additive to the surfaces of the toner mother particles. The external additive includes at least the fluororesin particles. An example of the mixer is an FM mixer (product of Nippon Coke & Engineering Co., Ltd.). The fluorine coverage rate can be adjusted by changing the amount of the fluororesin particles added into the mixer. Though the above, the toner including the toner particles is produced.

### Second Embodiment: Image Forming Apparatus

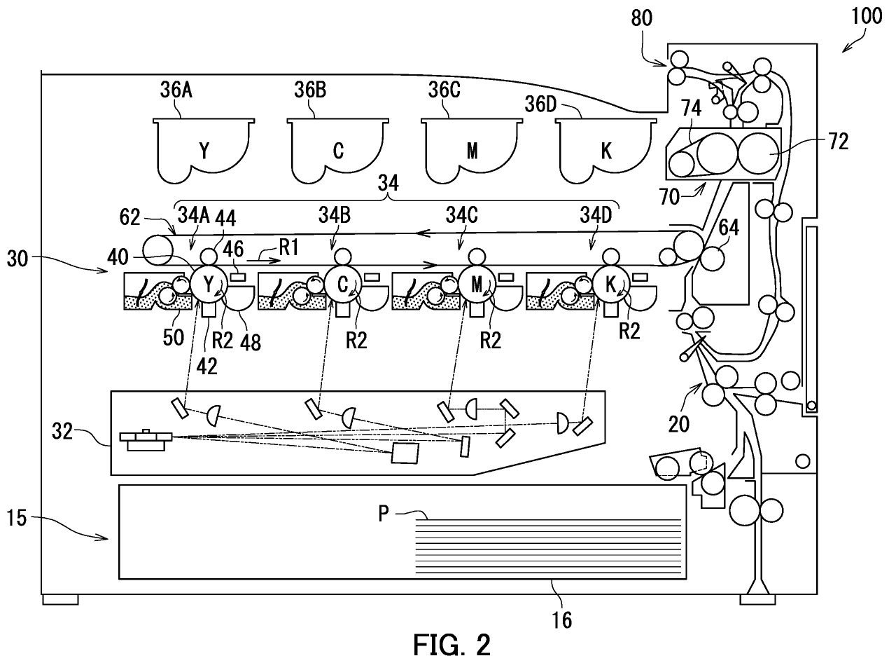

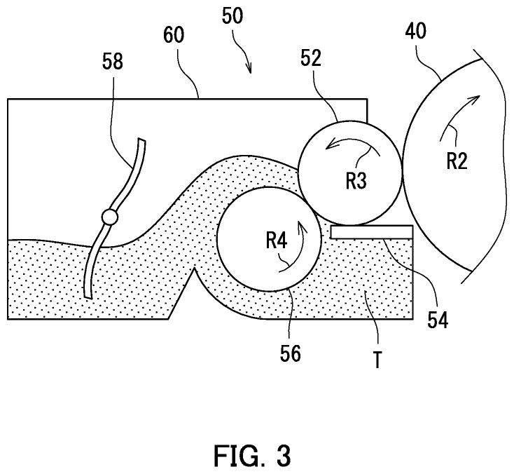

The following describes an image forming apparatus according to a second embodiment of the present disclosure with reference to the drawings. FIG. 2 to be referred to is a diagram illustrating an example of a configuration of the image forming apparatus of the second embodiment. FIG. 3 to be referred to is a diagram illustrating a configuration of a development device included in the image forming apparatus in FIG. 2. Note that the drawings to be referred to schematically illustrate main elements of configuration in order to facilitate understanding. Aspects such as size, number, and shape of the elements of configuration illustrated in the drawings may differ from actual properties thereof in order to facilitate preparation of the drawings.

As illustrated in FIG. 2, an image forming apparatus 100 is a printer adopting the non-magnetic one-component development process for forming an image on a sheet P that is a recording medium. The image forming apparatus 100 includes a feeding section 15, a conveyance section 20, an image forming section 30, and an ejection section 80.

The feeding section 15 includes a cassette 16 that accommodates a plurality of sheets P. The sheets P are paper sheets or synthetic resin sheets, for example. The feeding section 15 feeds each sheet P to the conveyance section 20 on a sheet-by-sheet basis. The conveyance section 20 conveys the sheet P to the image forming section 30. The image forming section 30 forms an image on the sheet P. The conveyance section 20 conveys the sheet P with the image formed thereon to the ejection section 80. The ejection section 80 ejects the sheet P out of the image forming apparatus 100.

The image forming section 30 includes a light exposure unit 32, a first toner image generating unit 34A, a second toner image generating unit 34B, a third toner image generating unit 34C, a fourth toner image generating unit 34D, a first toner container 36A, a second toner container 36B, a third toner container 36C, a fourth toner container 36D, an intermediate transfer belt 62, a secondary transfer roller 64, and a fixing device 70. Here, the image forming apparatus 100 is a tandem image forming apparatus in which the first toner image generating unit 34A, the second toner image generating unit 34B, the third toner image generating unit 34C, and the fourth toner image generating unit 34D are arranged in a line along the intermediate transfer belt 62.

Note that in order to avoid redundancy in the following description of the present specification, the first toner image generating unit 34A, the second toner image generating unit 34B, the third toner image generating unit 34C, and the fourth toner image generating unit 34D may be respectively referred to as a toner image generating unit 34A, a toner image generating unit 34B, a toner image generating unit 34C, and a toner image generating unit 34D. Similarly, the first toner container 36A, the second toner container 36B, the third toner container 36C, and the fourth toner container 36D may be respectively referred to as a toner container 36A, a toner container 36B, a toner container 36C, and a toner container 36D.

The light exposure unit 32 irradiates the toner image generating units 34A to 34D with light based on image data to form electrostatic latent images on the respective toner image generating units 34A to 34D.

The toner image generating unit 34A forms a yellow toner image based on a corresponding one of the electrostatic latent images. The toner image generating unit 34B forms a cyan toner image based on a corresponding one of the electrostatic latent images. The toner image generating unit 34C forms a magenta toner image based on a corresponding one of the electrostatic latent images. The toner image generating unit 34D forms a black toner image based on a corresponding one of the electrostatic latent images.

The toner container 36A contains a toner for forming yellow toner images. The toner container 36B contains a toner for forming cyan toner images. The toner container 36C contains a toner for forming magenta toner images. The toner container 36D contains a toner for forming black toner images. The toners contained in the toner containers 36A to 36D each are the aforementioned toner of the first embodiment (toner T illustrated in FIG. 3).

The intermediate transfer belt 62 circulates in a direction of an arrow R1. The intermediate transfer belt 62 has an outer surface to which the toner images in the respective four colors are transferred sequentially from the toner image generating units 34A to 34D. The secondary transfer roller 64 transfers the toner images formed on the outer surface of the intermediate transfer belt 62 to the sheet P. The fixing device 70 fixes the toner images to the sheet P by applying heat and pressure to the sheet P.

Overview of the configuration of the image forming apparatus 100 has been described so far. Details of the configuration of the image forming apparatus 100 will be described next. Note that each of the toner image generating unit 34A, the toner image generating unit 34B, the toner image generating unit 34C, and the toner image generating unit 34D is referred to as a toner image generating unit 34 where it is not necessary to distinguish between the toner image generating units 34A to 34D.

The toner image generating unit 34 includes a charger 42, a development device 50, a primary transfer roller 44, a static eliminator 46, a cleaner 48, and a photosensitive drum 40 as an image bearing member. In the toner image generating unit 34, the charger 42, the development device 50, the primary transfer roller 44, the static eliminator 46, and the cleaner 48 are arranged in the stated order around the circumferential surface of the photosensitive drum 40.

The photosensitive drum 40 is disposed in contact with the outer surface of the intermediate transfer belt 62. The primary transfer roller 44 is disposed opposite to the photosensitive drum 40 with the intermediate transfer belt 62 therebetween.

The photosensitive drum 40 rotates in a direction of an arrow R2. The charger 42 charges the circumferential surface of the photosensitive drum 40. The circumferential surface of the photosensitive drum 40 is irradiated with light by the light exposure unit 32, thereby forming an electrostatic latent image.

Examples of the photosensitive drum 40 that can be used include a photosensitive member including a photosensitive layer containing amorphous silicon and a photosensitive member including a photosensitive layer containing an organic photoconductor.

As illustrated in FIG. 3, the development device 50 includes a development roller 52 as a toner bearing member, a layer-thickness limiting blade 54 as a layer-thickness limiting member, a supply roller 56, a stirring member 58, and a casing 60. The development device 50 develops the electrostatic latent image formed on the circumferential surface of the photosensitive drum 40 by supplying the toner T to the electrostatic latent image to attach the toner T to the electrostatic latent image. Through the above, a toner image is formed on the circumferential surface of the photosensitive drum 40.

The development roller 52 bears the toner T. The toner T is the aforementioned toner of the first embodiment (non-magnetic one-component developer). The toner T is supplied from a corresponding one of the toner containers (any of the toner containers 36A to 36D illustrated in FIG. 2). The development roller 52 is disposed in contact with the photosensitive drum 40 so as to passively rotate in a direction of an arrow R3 as the photosensitive drum 40 rotates. The development roller 52 supplies the toner T borne by the development roller 52 to the photosensitive drum 40.

The layer-thickness limiting blade 54 limits the thickness of a toner layer (not illustrated) formed from the toner T. The toner layer is formed on the development roller 52. The layer-thickness limiting blade 54 has an end in contact with the circumferential surface of the development roller 52. The layer-thickness limiting blade 54 is for example a leaf spring and is pressed against the development roller 52 at a predetermined pressure. Examples of a constitutional material of the layer-thickness limiting blade 54 include resins (specific examples include silicone resin and urethane resin), metals (specific examples include stainless steel, aluminum, copper, brass, and phosphor bronze), and composite materials of these.

The supply roller 56 supplies the toner T to the development roller 52. The supply roller 56 is in contact with the development roller 52 and is supported so as to be rotatable in a direction of an arrow R4.

The stirring member 58 stirs the toner T and conveys the toner T toward the supply roller 56. The casing 60 accommodates the toner T and each component of the development device 50.

The development device 50 develops the electrostatic latent image formed on the circumferential surface of the photosensitive drum 40 into a toner image by supplying the toner T (specifically, the toner T included in the toner layer) to the electrostatic latent image while forming the toner layer using the layer-thickness limiting blade 54 in contact with the development roller 52.

With reference to FIG. 2, details of the configuration of the image forming apparatus 100 will be further described below. The primary transfer roller 44 transfers the toner image formed on the circumferential surface of the photosensitive drum 40 to the outer surface of the intermediate transfer belt 62. The static eliminator 46 performs static elimination on the circumferential surface of the photosensitive drum 40 after transfer of the toner image to the intermediate transfer belt 62. The cleaner 48 removes residual toner T from the circumferential surface of the photosensitive drum 40.

The toner image transferred to the outer surface of the intermediate transfer belt 62 is transferred to the sheet P by the secondary transfer roller 64. That is, the secondary transfer roller 64 is equivalent to a transfer section that transfers the toner image formed on the circumferential surface of the photosensitive drum 40 to the sheet P via the intermediate transfer belt 62. The sheet P to which the toner image has been transferred is conveyed to the fixing device 70 by the conveyance section 20. The fixing device 70 includes a pressure roller 72 that applies pressure to the toner image transferred to the sheet P and a fixing belt 74 that applies heat to the toner image transferred to the sheet P. Note that a fixing roller may be used instead of the fixing belt 74. The sheet P conveyed to the fixing device 70 receives heat and pressure between the pressure roller 72 and the fixing belt 74. Through the above, the toner image (image) is fixed to the sheet P. Thereafter, the sheet P is ejected out of the image forming apparatus 100 through the ejection section 80. The image forming apparatus 100 forms an image on a sheet P in a manner as described above.

The image forming apparatus 100, which uses the toner of the first embodiment as a non-magnetic one-component developer, can inhibit production of image defects.

An example of the image forming apparatus of the second embodiment has been described so far. However, the image forming apparatus according to the present disclosure is not limited to the above-described image forming apparatus 100. For example, the image forming apparatus according to the present disclosure may be a monochrome image forming apparatus. The monochrome image forming apparatus includes one toner image generating unit and one toner container, for example.

Furthermore, the image forming apparatus according to the present disclosure may be an image forming apparatus adopting a direct transfer process. In the image forming apparatus adopting the direct transfer process, the transfer section directly transfers the toner image on the image bearing member to a recording medium.

### Third Embodiment: Image Formation Method

The following describes an image formation method according to a third embodiment of the present disclosure. The image formation method of the third embodiment is a method for forming an image for example using the above-described image forming apparatus of the second embodiment. The image formation method of the third embodiment includes forming an electrostatic latent image and developing. Alternatively, the image formation method of the third embodiment may include any process (additional process) besides the forming an electrostatic latent image and the developing. Examples of the additional process include transferring and fixing. A preferable example of the image formation method of the third embodiment will be described below.

A preferable example of the image formation method of the third embodiment includes forming an electrostatic latent image, developing, transferring, and fixing.

In the forming an electrostatic latent image, an electrostatic latent image is formed on the surface of an image bearing member (e.g., the photosensitive drum 40 illustrated in FIG. 2). In the developing, the electrostatic latent image is developed into a toner image by supplying a toner to the electrostatic latent image while forming a toner layer using a layer-thickness limiting member (e.g., the layer-thickness limiting blade 54 illustrated in FIG. 3) in contact with a toner bearing member (e.g., the development roller 52 illustrated in FIG. 3). In the developing, the toner forming the toner layer (toner having been supplied to the electrostatic latent image) is the aforementioned toner of the first embodiment (non-magnetic one-component developer). In the transferring, the toner image formed by supplying the toner to the electrostatic latent image is transferred to a recording medium (e.g., the sheet P illustrated in FIG. 2). In the fixing, the transferred toner image is fixed to the recording medium (e.g., the sheet P illustrated in FIG. 2).

The preferable example of the image formation method of the third embodiment, which uses the toner of the first embodiment as a non-magnetic one-component developer, can inhibit occurrence of image defects.

### EXAMPLES

The following describes Examples of the present disclosure. However, the present disclosure is not limited to the scope of Examples.

<Preparation of Fluororesin Particles>

The following describes methods for preparing fluororesin particles F1 to F5.

[Preparation of Fluororesin Particles F1]

(Preparatory Process)

An autoclave equipped with an anchor type stainless steel stirring blade and a jacket for temperature adjustment was charged with 3.5 L of ion exchange water, 5 g of ammonium perfluorohexanoate, and 35 g of a paraffin wax (“PARAFFIN WAX-115”, product of Nippon Seiro Co., Ltd.). Then, the internal air of the autoclave was replaced by nitrogen gas and tetrafluoroethylene gas while the internal temperature of the autoclave was kept at 80° C.

(Polymerization Process)

Next, an ammonium persulfate solution (specifically, an aqueous solution obtained by dissolving 400 mg of ammonium persulfate in 25 mL of ion exchange water) as a polymerization initiator solution was added under pressure into the autoclave. Then, tetrafluoroethylene gas was supplied to the autoclave continuously to cause a polymerization reaction of tetrafluoroethylene. During the polymerization reaction, the internal temperature of the autoclave was kept at 80° C. and the autoclave contents were continuously stirred at a rotational speed of 250 rpm. Furthermore, during the polymerization reaction, the internal pressure of the autoclave was kept at 0.80±0.05 MPa. After the elapse of 45 minutes from the start of addition under pressure of the polymerization initiator solution (start of stirring the autoclave contents), the supply of the tetrafluoroethylene gas was stopped and the stirring of the autoclave contents was stopped to terminate the polymerization reaction. In the following, a time period from the start of addition under pressure of the polymerization initiator solution (start of stirring of the autoclave contents) to the stop of supply of the tetrafluoroethylene gas (stop of stirring of the autoclave contents) will be referred to as polymerization time.

(Precipitation Process)

Next, 20 mL of concentrated nitric acid at a concentration of 60% by mass was added to 3000 g of a dispersion as a result of the polymerization process (autoclave contents), and the dispersion to which the concentrated nitric acid had been added was stirred at a rotational speed of 350 rpm for 1 hour to precipitate a polymer (PTFE).

Next, the dispersion after the precipitation was subjected to solid-liquid separation and the resultant solid was dried. Thus, a powder of fluororesin particles F1 constituted by PTFE was obtained.

[Preparation of Fluororesin Particles F2]

A powder of fluororesin particles F2 was obtained according to the same method as that for preparing the fluororesin particles F1 in all aspects other than that the polymerization time was changed to 40 minutes in the polymerization process and the rotational speed (stirring speed) in stirring the dispersion was changed to 500 rpm in the precipitation process.

[Preparation of Fluororesin Particles F3]

A powder of fluororesin particles F3 was obtained according to the same method as that for preparing the fluororesin particles F1 in all aspects other than that the polymerization time was changed to 55 minutes in the polymerization process and the rotational speed (stirring speed) in stirring the dispersion was changed to 300 rpm in the precipitation process.

[Preparation of Fluororesin Particles F4]

A powder of fluororesin particles F4 was obtained according to the same method as that for preparing the fluororesin particles F1 in all aspects other than that the polymerization time was changed to 35 minutes in the polymerization process and the rotational speed (stirring speed) in stirring the dispersion was changed to 500 rpm in the precipitation process.

[Preparation of Fluororesin Particles F5]

A powder of fluororesin particles F5 was obtained according to the same method as that for preparing the fluororesin particles F1 in all aspects other than that the polymerization time was changed to 60 minutes in the polymerization process and the rotational speed (stirring speed) in stirring the dispersion was changed to 250 rpm in the precipitation process.

<Toner Production>

The following describes methods for producing toners TA-1 to TA-4 and TB-1 to TB-5.

[Production of Toner TA-1]

(Polyester Resin Synthesis)

A reaction vessel was charged with 1.0 mol of bisphenol A ethylene oxide adduct (average number of moles added of ethylene oxide: 2 mol), 4.5 mol of terephthalic acid, 0.5 mol of trimellitic anhydride, and 4.0 g of dibutyl tin oxide. Subsequently, the vessel contents were allowed to react for 8 hours at a temperature of 230° C. under the atmospheric pressure of a nitrogen atmosphere. Thereafter, the internal pressure of the vessel was reduced to 8.3 kPa and unreacted components were distilled off under the reduced pressure. As a result, a polyester resin (binder resin) with a softening point (Tm) of 120° C. was obtained.

(Toner Mother Particle Preparation)

An FM mixer (“FM-20B”, product of Nippon Coke & Engineering Co., Ltd.) was charged with 100 parts by mass of the polyester resin obtained through the above synthesis, 5 parts by mass of a carbon black (“REGAL (registered Japanese trademark) 330R”, product of Cabot Corporation) as a colorant, 10 parts by mass of a carnauba wax (“CARNAUBA WAX No. 1”, product of S. Kato & Co.) as a releasing agent, and 3 parts by mass of a positively chargeable charge control agent (“ACRYBASE (registered Japanese trademark) FCA-201-PS”, product of FUJIKURA KASEI CO., LTD.), and these materials were mixed at a rotational speed of 2000 rpm for 4 minutes using the FM mixer.

Subsequently, the resultant mixture was melt-kneaded at a temperature of 150° C. using a twin screw extruder (“TEM45”, product of Toshiba Machine Co., Ltd.). The resultant melt-kneaded product was subsequently cooled. Subsequently, the cooled melt-kneaded product was coarsely pulverized using a pulverizer (“FEATHER MILL (registered Japanese trademark) Model 350×600”, product of Hosokawa Micron Corporation). Subsequently, the resultant coarsely pulverized product was finely pulverized using a jet pulverizer (“JET MILL IDS-2”, product of Nippon Pneumatic Mfg. Co., Ltd.). Subsequently, the finely pulverized product was classified using a classifier (“ELBOW JET Model EJ-LABO”, product of Nittetsu Mining Co., Ltd.). Through the above, toner mother particles with a volume median diameter (D₅₀) of 8 μm were obtained.

(External Additive Addition)

An FM mixer (“FM-10B”, product of Nippon Coke & Engineering Co., Ltd.) was charged with 100 parts by mass of the toner mother particles (toner mother particles obtained through the above-described preparation), 2.00 parts by mass of hydrophobic silica particles (“CAB-O-SIL (registered Japanese trademark) TG-7120”, product of Cabot Corporation), and 0.30 parts by mass of the fluororesin particles F1. Next, the toner mother particles and an external additive (including the hydrophobic silica particles and the fluororesin particles F1) were mixed for 5 minutes using the FM mixer under conditions of a rotational speed of 3500 rpm and a jacket temperature of 20° C. Through the above, the entire amount of the external additive was attached to the surfaces of the toner mother particles.

Subsequently, the resultant powder was sifted using a 200-mesh sieve (opening 75 μm). Through the above, a positively chargeable toner TA-1 was obtained. Note that the composition ratio of the components constituting the toner did not change before or after the sifting.

[Production of Toners TA-2 to TA-4 and TB-1 to TB-4]

Each of positively chargeable toners TA2 to TA-4 and TB-1 to TB-4 was produced according to the same method as that for producing the toner TA-1 in all aspects other than the type and amount of the fluororesin particles were changed to those shown in Table 1 below.

[Production of Toner TB-5]

A positively chargeable toner TB-5 was produced according to the same method as that for producing the toner TA-1 in all aspects other than that 0.30 parts by mass of acrylic resin particles (“FINE SPHERE (registered Japanese trademark) FS-101”, product of Nippon Paint Industrial Coatings Co., Ltd.) were used instead of 0.30 parts by mass of the fluororesin particles F1 in the external additive addition.

<Determination of Fluorine Coverage Rate>

A backscattered electron image of the toner particles of a measurement target toner (any of the toners TA-1 to TA-4 and TB-1 to TB-4) was captured at a magnification of 10,000× using a field emission scanning electron microscope (FE-SEM, “JSM-7600F”, product of JEOL Ltd.).

Next, 10 toner particles were randomly selected in the captured backscattered electron image. Next, a fluorine coverage rate was determined for each of the selected 10 toner particles using image analysis software (“WinROOF”, product of MITANI CORPORATION). In detail, fluorine contained in fluororesin particles was mapped in the backscattered electron image using an energy dispersive X-ray (EDX) analyzer attached to the FE-SEM. Through the mapping, a boundary between a region occupied by the fluororesin particles and a region occupied by components other than the fluororesin particles was clarified in the backscattered electron image. Note that as to a part of the surface of each toner mother particle where multiple types of external additive particles overlapped with one another, the part was determined to be covered with an uppermost-located external additive particle (specifically, an external additive particle present at the highest location relative to the surface of the toner mother particle). For example, a part of the surface of the toner mother particle where a hydrophobic silica particle and a fluororesin particle overlapped with each other in the stated order from the surface of the toner mother particle was determined to be covered with the uppermost fluororesin particle. Next, a total area of regions of the surface of the toner mother particle that were covered with the fluororesin particles (total of projected areas of the fluororesin particles) and an area of a region surrounded by a contour indicating the outer perimeter of the toner mother particle were obtained. Then, a fluorine coverage rate was calculated using a formula “(fluorine coverage rate)=100×(total area of regions of surface of toner mother particle covered with fluororesin particles)/(area of a region surrounded by contour indicating outer perimeter of toner mother particle)”. A number average value of the resultant 10 calculated values was taken to be an evaluation value (fluororesin coverage rate) of the measurement target toner.

With respect to each of the toners TA-1 to TA-4 and TB-1 to TB-5, the type, amount, and number average primary particle diameter of the resin particles used and the fluorine coverage rate are shown in Table 1. Note that “Amount” under the column titled “Resin particles” in Table 1 indicates an amount of each type of the resin particles (unit: part by mass) added into the FM mixer relative to 100 parts by mass of the toner mother particles. Also, “-” in Table 1 indicates that the fluorine coverage rate was not determined because no fluororesin particles were used.

TABLE 1

| | Resin particles | | | |
|---|---|---|---|---|
| | | Amount | Number average | Fluorine |
| | | [part | primary particle | coverage |
| | | by | diameter | rate |
| Toner | Type | mass] | [nm] | [%] |
| TA-1 | Fluororesin particles F1 | 0.30 | 200 | 1.09 |
| TA-2 | Fluororesin particles F2 | 0.30 | 100 | 0.72 |
| TA-3 | Fluororesin particles F3 | 0.30 | 300 | 0.98 |
| TA-4 | Fluororesin particles F1 | 0.60 | 200 | 2.17 |
| TB-1 | Fluororesin particles F4 | 0.25 | 80 | 1.89 |
| TB-2 | Fluororesin particles F5 | 0.30 | 350 | 0.93 |
| TB-3 | Fluororesin particles F1 | 0.65 | 200 | 2.35 |
| TB-4 | Fluororesin particles F1 | 0.15 | 200 | 0.54 |
| TB-5 | Acrylic resin particles | 0.30 | 100 | — |

<Evaluation Method>

The following describes methods for evaluating each of the toners TA-1 to TA-4 and TB-1 to TB-5.

[Fogging Density]

An evaluation apparatus used was a monochrome laser printer adopting the non-magnetic one-component development process (“HL-1218W”, product of BROTHER INDUSTRIES, LTD.). An evaluation toner (evaluation target: any of the toners TA-1 to TA-4 and TB-1 to TB-5) was loaded into a development device and a toner container of the evaluation apparatus. Next, an image with a printing rate of 5% was consecutively printed on 1500 sheets of printing paper (A4-size plain paper) using the evaluation apparatus in an environment at a temperature of 23° C. and a relative humidity of 50%.

Next, an image with a printing rate of 5% was printed on one sheet of printing paper (A4-size plain paper) using the evaluation apparatus in an environment of a temperature of 23° C. and a relative humidity of 50%, thereby obtaining an evaluation image. The image density (ID) of a blank part of the obtained evaluation image was measured using a reflectance densitometer (“SPECTROEYE (registered Japanese trademark”, product of X-Rite Inc.) and a fogging density (FD) was calculated. Note that the fogging density (FD) corresponds to a value obtained by subtracting the image density (ID) of base paper (unused printing paper) from the image density (ID) of the blank part of the evaluation image.

A fogging density (FD) of less than 0.010 was evaluated as “occurrence of fogging inhibited”. By contrast, a fogging density (FD) of at least 0.010 was evaluated as “occurrence of fogging not inhibited”.

[Streak Inspection]

The evaluation image obtained in evaluation in [Fogging Density] described above was visually observed. An evaluation image with no streaks (specifically, white streaks) was evaluated as “occurrence of streak formation inhibited”. By contrast, an evaluation image with a streak was evaluated as “occurrence of streak formation not inhibited”.

<Evaluation Results>

Table 2 shows the fogging density (FD) and the presence or absence of a streak in the evaluation image with respect to each of the toners TA-1 to TA-4 and TB-1 to TB-5.

TABLE 2

| | | Fogging | Presence or absence of |
|---|---|---|---|
| | Toner | density | streak in evaluation image |
| Example 1 | TA-1 | 0.002 | Absent |
| Example 2 | TA-2 | 0.001 | Absent |
| Example 3 | TA-3 | 0.001 | Absent |
| Example 4 | TA-4 | 0.006 | Absent |
| Comparative Example 1 | TB-1 | 0.009 | Present |
| Comparative Example 2 | TB-2 | 0.001 | Present |
| Comparative Example 3 | TB-3 | 0.015 | Absent |
| Comparative Example 4 | TB-4 | 0.001 | Present |
| Comparative Example 5 | TB-5 | 0.001 | Present |

As shown in Table 1, the external additive included fluororesin particles with a number average primary particle diameter of at least 100 nm and no greater than 300 nm in each of the toners TA-1 to TA-4. The toners TA-1 to TA-4 each had a fluorine coverage rate of at least 0.70% and no greater than 2.20%.

As shown in Table 2, the toners TA-1 to TA-4 each had a fogging density (FD) of less than 0.010. As such, the toners TA-1 to TA-4 inhibited occurrence of fogging. In each of the toners TA-1 to TA-4, no streaks were present in the evaluation image. As such, the toners TA-1 to TA-4 inhibited occurrence of streak formation.

As shown in Table 1, the fluororesin particles of the external additive in the toner TB-1 had a number average primary particle diameter of less than 100 nm. The fluororesin particles of the external additive in the toner TB-2 had a number average primary particle diameter of greater than 300 nm. In the toner TB-3, the fluorine coverage rate was greater than 2.20%. In the toner TB-4, the fluorine coverage rate was less than 0.70%. In the toner TB-5, the external additive included no fluororesin particles.

As shown in Table 2, the fogging density (FD) was at least 0.010 in the toner TB-3. As such, the toner TB-3 did not inhibit occurrence of fogging. In each of the toners TB-1, TB-2, TB-4, and TB-5, a streak was present in the evaluation image. As such, the toners TB-1, TB-2, TB-4, and TB-5 did not inhibit occurrence of streak formation.

From the results described above, it was demonstrated that the toner according to the present disclosure can inhibit production of imaged defects in image formation by the non-magnetic one-component development process.

What is claimed is:

1. A toner comprising toner particles, wherein
the toner particles each include a toner mother particle containing a binder resin and an external additive attached to a surface of the toner mother particle,
the external additive includes fluororesin particles,
the fluororesin particles have a number average primary particle diameter of at least 100 nm and no greater than 300 nm, and
an area ratio of a region of the surface of the toner mother particle that is covered with the fluororesin particles is at least 0.70% and no greater than 2.20% in the surface of the toner mother particle.

2. The toner according to claim 1, wherein
the area ratio of the region of the surface of the toner mother particle that is covered with the fluororesin particles is at least 0.72% and no greater than 1.09% in the surface of the toner mother particle.

3. The toner according to claim 1, wherein
the fluororesin particles contain polytetrafluoroethylene.

4. The toner according to claim 1, wherein
an amount of the fluororesin particles is at least 0.30 parts by mass and no greater than 0.60 parts by mass relative to 100 parts by mass of the toner mother particles.

5. The toner according to claim 1, wherein
the external additive further includes inorganic particles.

6. An image forming apparatus comprising:
an image bearing member; and
a development device configured to develop an electrostatic latent image formed on a surface of the image bearing member by supplying a non-magnetic one-component developer to the electrostatic latent image, wherein
the non-magnetic one-component developer is the toner according to claim 1,
the development device includes a toner bearing member that bears the toner and a layer-thickness limiting member that limits a thickness of a toner layer formed from the toner, and
the development device supplies the toner to the electrostatic latent image while forming the toner layer using the layer-thickness limiting member in contact with the toner bearing member.

7. The image forming apparatus according to claim 6, further comprising:
a transfer section configured to transfer a toner image to a recording medium, the toner image being formed as a result of the toner being supplied to the electrostatic latent image; and
a fixing device configured to fix the toner image to the recording medium.

8. An image formation method that uses the toner according to claim 1 as a non-magnetic one-component developer, comprising:
forming an electrostatic latent image on a surface of an image bearing member; and
developing the electrostatic latent image by suppling the toner to the electrostatic latent image while forming a toner layer formed from the toner using a layer-thickness limiting member in contact with a toner bearing member.

9. The image formation method according to claim 8, further comprising:
transferring a toner image to a recording medium, the toner image being formed as a result of the toner being supplied to the electrostatic latent image; and
fixing the transferred toner image to the recording medium.
